(19) United States
(12) Patent Application Publication
(10) Pub. No.: US 2005/0140346 A1
(43) Pub. Date: Jun. 30, 2005

(54) Method and apparatus for reducing low-frequency current ripple on a direct current supply line

(76) Inventor: Eliahu Ashkenazy, Tallahassee, FL (US)

Correspondence Address: Thomas C. Steidel, 1721 W. Paul Dirac Drive, Tallahassee, FL, 32310, US

(21) Appl. No.: 11/024,087

(22) Filed: Dec. 28, 2004

Related U.S. Application Data
(60) Provisional application No. 60/532,875, filed on Dec. 29, 2003.

(51) Int. Cl. H02M 3/335

(52) U.S. Cl. 323/275

(57) ABSTRACT

A method and apparatus for reducing low-frequency current ripple on a direct current (DC) supply line is disclosed in its basic embodiment, and in an enhanced performance form. By replacing the large inductance in the series-inductance, shunt-capacitance filter model that is commonly used in this application with a solid-state, constant-current device, an efficient, low-loss apparatus capable of outperforming traditional methods in this role is realized especially in military communications applications where MIL-STD-461E requirements must be met in a compact form.

Under the provisions of 37 CFR 1.78, the benefit of an earlier filing date as a provisional patent application, No. 60/532,875, with an official filing date of Dec. 29, 2003, is hereby claimed.

### BACKGROUND

1. Technical Field of the Invention

The present invention relates to a novel method and apparatus for reducing unwanted low-frequency current ripple on a Direct Current (DC) supply line input to an electrical or electronic load especially where performance of the load or another unrelated device is adversely affected by current ripple present on the DC supply line, either due to inherent instabilities of the supply, or, more specifically, to fluctuations caused by surges in current drawn by the load itself.

2. Description of Related Art

Combinations of series inductances and shunt capacitances have long been used to reduce unwanted current ripple on DC supply lines, and are common in the literature. However, the size and weight of any such combination becomes unwieldy and less effective in applications where low frequency fluctuations on high-current DC supply lines must be limited or eliminated. Further, because the series-shunt combinations have resistive characteristics, losses in the form of heat, especially in series inductances, result in unwanted heat loads that must be dissipated, and in accompanying inefficiencies. In mobile and portable apparatus applications where available power is limited, where excessive heat build-up is very undesirable, where size and weight are constrained, and where circuit efficiency is mandated, the traditional methods using combinations of series inductances and shunt capacitances fail to meet most if not all of these requirements. This is particularly true in military communications applications where one or more of the stringent requirements of MIL-STD-461E must be met.

What is needed, then, is a method that accomplishes the task of reducing or eliminating the unwanted current ripple effects with minimal resistive losses and maximum efficiency. The same method should also offer reductions in size and weight, while offering improved performance over the traditional methods at very low frequencies of fluctuation and at high current levels. Further, this method should satisfy MIL-STD-461E requirements when applied to military communications applications.

### SUMMARY OF THE INVENTION

Various advantages of this invention become readily apparent upon reading the accompanying drawings and descriptions set forth herein. Specifically, one of the advantages of this invention is that the series inductance required to limit current fluctuations on the DC supply line is replaced by an active device that acts like a constant current gate. As a result, resistive losses and heat generation are minimized, size and weight of the invention are reduced, and efficiency is markedly improved.

Another advantage of this invention is improved isolation of ripple current caused by low-frequency fluctuations of current drawn by the load, from the DC supply line. This advantage makes the invention particularly suited for military communications applications where the stringent requirements of MIL-STD-461E must be met.

Yet another advantage of this invention is an improvement in performance where low-frequency fluctuations in high-current applications are evident since the invention overcomes the limitations of real inductors at low frequencies; namely, size, weight, and electrical resistance resulting in heat loss.

These and other advantages not described but inherently obvious to the reader are fully embraced by this invention.

### BRIEF DESCRIPTION OF THE DRAWINGS

A more complete understanding of this invention may be gained by reading the following detailed description while referring to the accompanying drawings herein:

FIG. 1 is a functional block diagram of the invention.

FIG. 2 is a functional block diagram of a variation of the invention that incorporates a voltage regulation circuit at its output.

### DETAILED DESCRIPTION

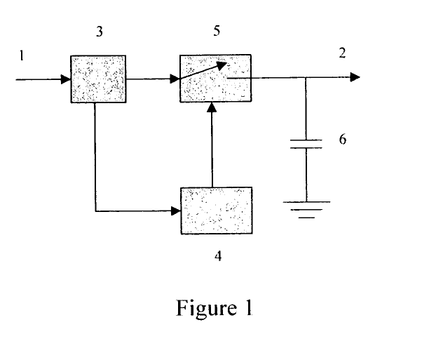

FIG. 1 is a block diagram depicting the key functional elements of the invention. Input 1 is connected to a primary source of direct current (DC) voltage. Output 2 is connected to an electrical or electronic load, commonly an active consumer of the power supplied by the primary source. While this invention anticipates a power amplifier or other communications equipment as the load, it must be understood that the invention fully embraces other types of loads not discussed or considered further herein.

Power demands for loads of the kind anticipated by this invention are known to fluctuate over time, according to the application served. Many communications waveforms cause these fluctuations in current draw to vary widely in a cyclic fashion at low repetition frequencies typically less than 200 Hertz.

A sampling and detecting means 3 at the input of the invention takes small, continuous analog samples of the DC supply voltage, detecting low-frequency current ripple present on the supply line.

A circuit 4 simultaneously converts the detected current ripple to a gating voltage that is applied to a solid-state, constant-current device 5 that interconnects the input 1 and output 2 in a serial fashion. In a preferred embodiment, this device is a field effect transistor (FET). The device 5 is biased to hold the DC supply current passing through it at a near-constant level, this bias level being modulated by the gating voltage to effectively cancel the effects of the current ripple detected at the input 1. A large shunt capacitance 6 is placed on the connection between the output of device 4 and output 2 of the invention to further smooth the DC supply voltage at the output 2.

Comparing this invention to the combination of series inductance and shunt capacitance commonly used to remove current ripple at characteristically higher frequencies and lower supply current levels, it can be seen that the constant-current device 5 functions as an “active,” large, low-loss series inductance in the apparatus. In addition, the constant-current device 5 provides excellent isolation of load-generated current ripple from the DC supply line, a benefit over series inductance.

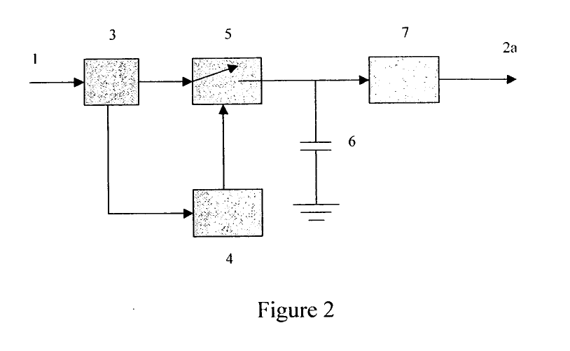

In a preferred embodiment of the invention, as depicted in FIG. 2, a voltage-regulating circuit 7 is added at the output 2, interconnecting the output 2 to a new apparatus output 2a, to further condition and regulate the output of the apparatus. While this invention anticipates the use of a switch-mode power supply as the voltage-regulating circuit 7, any number of circuits that perform a similar function can be substituted for the voltage-regulating circuit 7, and are fully embraced by this invention. A switch-mode power supply offers the added benefit of providing a voltage conversion from that of the input to the apparatus to a desired, alternate voltage at the output.

1. A method for reducing current ripple on a direct current (DC) supply line the method comprising:
a. sampling the supply line current at the input;
b. detecting current ripple present in the sample of the supply line current;
c. converting the detected current ripple into a related gating voltage;
d. applying the gating voltage to a solid-state constant-current device that is in series with the supply line input; and
e. smoothing the output of the constant-current device with shunt capacitance at the output.

2. The method of claim 1, further comprising the step of regulating the output voltage of the DC supply line.

3. An apparatus for reducing current ripple on a DC supply line, comprising:
a. an input and an output, these being interconnected serially by a solid-state constant-current device having a gating voltage input;
b. a means to sample and detect the current ripple present at the apparatus input, this means having an output;
c. a circuit having an input and output, its input being connected to the output of the means to sample and detect the current ripple, the circuit deriving a gating voltage at its output that is related to the detected current ripple, the output gating voltage being connected to the constant-current device at its gating voltage input; and
d. a shunt capacitance connected to the output of the apparatus.

4. The apparatus of claim 3 further comprising a voltage-regulating circuit having an input and output, its input connected to the output of the apparatus of claim 3, and its output now forming the output of the apparatus.

5. The apparatus of claim 4 wherein the voltage-regulating circuit is comprised of a switch-mode power supply.
